(19) United States
(12) Patent Application Publication
(10) Pub. No.: US 2026/0087209 A1
(43) Pub. Date: Mar. 26, 2026

(54) DIGITAL TWIN MODELING METHOD AND SYSTEM FOR ELECTRO-HYDRAULIC ACTUATOR WITH EDGE-CLOUD COLLABORATION

(71) Applicant: Shanghai Jiao Tong University, Shanghai (CN)

(72) Inventors: Qun CHAO, Shanghai (CN); Benran ZHU, Shanghai (CN); Chengliang LIU, Shanghai (CN); Jing CHEN, Shanghai (CN); Wentao WANG, Shanghai (CN)

(73) Assignee: Shanghai Jiao Tong University, Shanghai (CN)

(21) Appl. No.: 19/380,391

(22) Filed: Nov. 5, 2025

(30) Foreign Application Priority Data
Mar. 13, 2025 (CN) 202510299220.7

(51) Int. Cl. G06F 30/27; G06F 111/02

(52) U.S. Cl. CPC G06F 30/27; G06F 2111/02

(57) ABSTRACT

A digital twin modeling method for an electro-hydraulic actuator with edge-cloud collaboration is provided in the present disclosure. The method includes: obtaining a plurality of simulation models of a target electro-hydraulic actuator, and generating simulation data using the simulation models; obtaining the plurality of surrogate models of the target electro-hydraulic actuator, and deploying the plurality of surrogate models on an edge device and a cloud server; collecting, by at least one physical sensor of the target electro-hydraulic actuator, operating condition data of the target electro-hydraulic actuator in real time; determining, on the edge device and the cloud server, performance parameters of the target electro-hydraulic actuator under a current actual operating condition based on the operating condition data using the plurality of surrogate models; displaying a graph of the operating characteristic parameters and a 3D model of the target electro-hydraulic actuator mapped with the physical-field parameters.

### CROSS-REFERENCE TO RELATED APPLICATION

The present application is based upon and claims priority to Chinese Patent Application No. 202510299220.7, filed on Mar. 13, 2025, the entirety contents of which are incorporated herein by reference.

### TECHNICAL FIELD

The present disclosure is related to a technical field of electro-hydraulic actuator health monitoring, and more particularly, to a digital twin modeling method for an electro-hydraulic actuator with edge-cloud collaboration.

### BACKGROUND

Electro-hydraulic actuators are key execution units in hydraulic systems. They have the advantages of high response speed, high-precision control, and high dynamic performance, making them widely used in fields such as aerospace, engineering machinery, robotics, etc. The health status of the electro-hydraulic actuators will directly affect the working efficiency and safety of the hydraulic systems.

Traditional health monitoring methods rely on offline data or single sensors, leading to a poor real-time performance and low data utilization.

### SUMMARY

The purpose of the present disclosure is to provide a digital twin modeling method and system for an electro-hydraulic actuator with edge-cloud collaboration.

The digital twin modeling method for an electro-hydraulic actuator with edge-cloud collaboration provided in the present disclosure may include: obtaining a plurality of simulation models of a target electro-hydraulic actuator, and generating simulation data using the simulation models, in which low-dimensional data corresponding to the simulation data is configured to train a plurality of surrogate models corresponding to the plurality of simulation models; obtaining the plurality of surrogate models of the target electro-hydraulic actuator, and deploying the plurality of surrogate models on an edge device and a cloud server based on a computing power requirement and an input parameter quantity of the plurality of surrogate models; collecting, by at least one physical sensor of the target electro-hydraulic actuator, operating condition data of the target electro-hydraulic actuator in real time; determining, on the edge device and the cloud server, performance parameters of the target electro-hydraulic actuator under a current actual operating condition based on the operating condition data using the plurality of surrogate models, in which the performance parameters include physical-field parameters and operating characteristic parameters, and the physical-field parameters include a stress-field parameter, a flow-field parameter, and a temperature-field parameter; and displaying a graph of the operating characteristic parameters a 3D model of the target electro-hydraulic actuator mapped with the physical-field parameters.

The digital twin modeling system for an electro-hydraulic actuator with edge-cloud collaboration provided in the present disclosure may include: a processor, a memory, and a program or an instruction stored on the memory and executable on the processor, in which when the program or the instruction is executed by the processor, a digital twin modeling method for an electro-hydraulic actuator with edge-cloud collaboration is implemented, the method includes: obtaining a plurality of simulation models of a target electro-hydraulic actuator, and generating simulation data using the simulation models, in which low-dimensional data corresponding to the simulation data is configured to train a plurality of surrogate models corresponding to the plurality of simulation models; obtaining the plurality of surrogate models of the target electro-hydraulic actuator, and deploying the plurality of surrogate models on an edge device and a cloud server based on a computing power requirement and an input parameter quantity of the plurality of surrogate models; collecting, by at least one physical sensor of the target electro-hydraulic actuator, operating condition data of the target electro-hydraulic actuator in real time; determining, on the edge device and the cloud server, performance parameters of the target electro-hydraulic actuator under a current actual operating condition using the plurality of surrogate models, in which the performance parameters include physical-field parameters and operating characteristic parameters, and the physical-field parameters include a stress-field parameter, a flow-field parameter and a temperature-field parameter; and displaying a graph of the operating characteristic parameters and a 3D model of the target electro-hydraulic actuator mapped with the physical-field parameters.

It should be understood that the content described in this section is not intended to identify key or important features of the embodiments of the present disclosure, nor is it intended to limit the scope of the present disclosure. Additional features of the present disclosure will become easier to understand through the following description.

### BRIEF DESCRIPTION OF THE DRAWINGS

The accompanying drawings are used to better understand the solution, and do not constitute a limitation on the present disclosure, in which:

FIG. 1 is a flowchart of a digital twin modeling method for an electro-hydraulic actuator with edge-cloud collaboration in an exemplary embodiment of the present disclosure;

FIG. 2 is a flowchart of a digital twin modeling method in another exemplary embodiment of the present disclosure;

FIG. 3 is a flowchart of a training method for a surrogate model in an exemplary embodiment of the present disclosure;

FIG. 4 is a flowchart of an inference method for a surrogate model in an exemplary embodiment of the present disclosure;

FIG. 5 is a flowchart of a three-dimensional visualization method for an inference result in an exemplary embodiment of the present disclosure;

FIG. 6 is a block diagram of a digital twin operation system in an exemplary embodiment of the present disclosure.

### DETAILED DESCRIPTION

The following section describes the exemplary embodiments of the present disclosure with reference to the accompanying drawings, which includes various details of the embodiments of the present disclosure to facilitate understanding for the objectives, technical solutions, and advantages of the present disclosure. It should be understood that these descriptions are exemplary only and are not intended to limit the scope of the present disclosure. Furthermore, descriptions of well-known structures and technologies are omitted in the following description for clarity and conciseness.

The accompanying drawings show schematic diagrams of layer structure according to embodiments of the present disclosure. The accompanying drawings are not drawn to scale and some details may be exaggerated and omitted for clarity. The shapes of the various regions, layers and relative sizes, and positional relationships thereof shown in the drawings are merely exemplary and may deviate in practice due to manufacturing tolerances or technical limitations. Those skilled in the art may also design regions/layers with different shapes, sizes, and relative positions according to actual needs.

Obviously, the described embodiments are only part of the embodiments instead of all embodiments of the present disclosure. Those of ordinary skills in the art should recognize that various changes and modifications can be made to the embodiments described herein without departing from the scope and spirit of the present disclosure.

It should be noted that the terms such as “first”, “second”, and “third” in the description of the present disclosure are used merely for descriptive purposes and should not be understood as indicating or implying relative importance.

In addition, the technical features involved in the different embodiments of the present disclosure described below may be combined with each other as long as they do not conflict with each other.

Digital twin technology achieves accurate simulation and prediction by constructing virtual digital mirrors, which may reflect the operating condition of devices in real time and become an important means of fault diagnosis. However, building and updating digital twin models require processing large amounts of real-time data, and it is difficult to satisfy requirements of both low latency and high performance by relying solely on edge terminals or cloud platforms.

Edge-cloud collaborative computing technology may integrate the low-latency advantages of the edge terminals and the powerful data processing capabilities of the cloud platforms, so as to achieve real-time and high-precision modeling, providing a new technical path for the health monitoring of electro-hydraulic actuators, fault diagnosis, and system optimization. Currently, the efficient integration of sensor data within an edge-cloud collaborative architecture to achieve real-time interaction between virtual and physical environments, along with utilizing artificial intelligence algorithms for fault diagnosis, continues to present significant challenges.

The digital twin modeling method and system for an electro-hydraulic actuator with edge-cloud collaboration is described in the following exemplary embodiments of the present disclosure with reference to the accompanying drawings and disclosure scenarios.

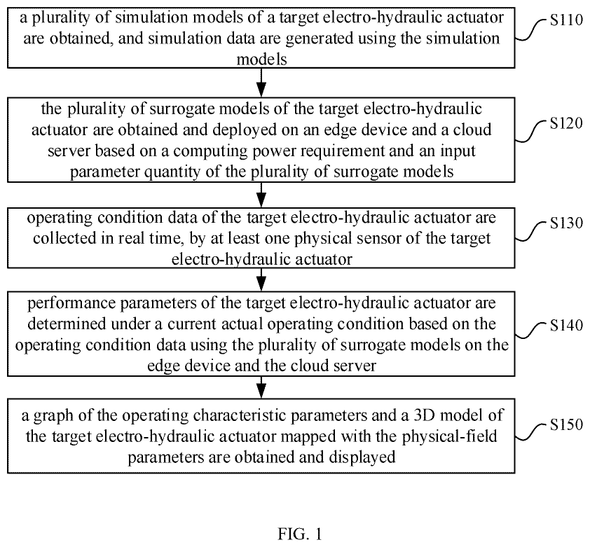

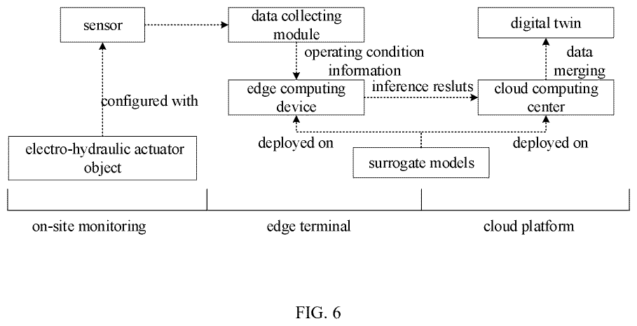

As shown in FIG. 1, in a first aspect of an embodiment of the present disclosure, a digital twin modeling method for an electro-hydraulic actuator with edge-cloud collaboration is provided. The modeling method may include the following steps. It should be understood that the digital twin modeling method may be described as parameter determining method, a digital twin generating method or a displaying method for an electro-hydraulic actuator with edge-cloud collaboration. The method may be executed by the operation system of a digital twin of the electro-hydraulic actuator shown in FIG. 6, or by a device equipped with such system. The method may include the following steps.

At step S110, a plurality of simulation models of a target electro-hydraulic actuator are obtained, and simulation data may be generated using the simulation models.

That is, high-fidelity simulation models of a target electro-hydraulic actuator are built using a simulation software, and simulation data are generated using the simulation model.

In some embodiments, simulation models of the target electro-hydraulic actuator may be obtained, for example, from one or more simulation software or from one or more devices equipped with the simulation software. The simulation model may include at least one of a structural stress simulation model, an electromagnetic simulation model, a fluid simulation model, and a system-level simulation model of the target electro-hydraulic actuator.

The simulation models may be used to generate simulation data. The original simulation data may be used to obtain low-dimensional simulation data (low-dimensional output described in the following embodiments), which means that the original simulation data may be regarded as high-dimensional output of the simulation model, and may be processed using reduced-order methods (reduced-order model or reduced-order process or model order reduction described in the following embodiments) to obtain the low-dimensional data.

The low-dimensional data corresponding to the simulation data is used to train multiple surrogate models of the target electro-hydraulic actuator. Each surrogate model may correspond to one simulation model. For example, the surrogate model may include at least one of a system-level surrogate model, a structural stress surrogate model, an electromagnetic surrogate model, a seal leakage surrogate model, and a fluid surrogate model. The system-level surrogate model corresponds to the system-level simulation model, the structural stress surrogate model (piston rod structural stress model as described in followings) corresponds to the structural stress simulation model, the electromagnetic surrogate model (force motor electromagnetic model as described in followings) corresponds to the electromagnetic simulation model, the fluid surrogate model (solenoid valve fluid model as described in followings) corresponds to the fluid simulation model, and the seal leakage surrogate model belongs to the system-level surrogate model.

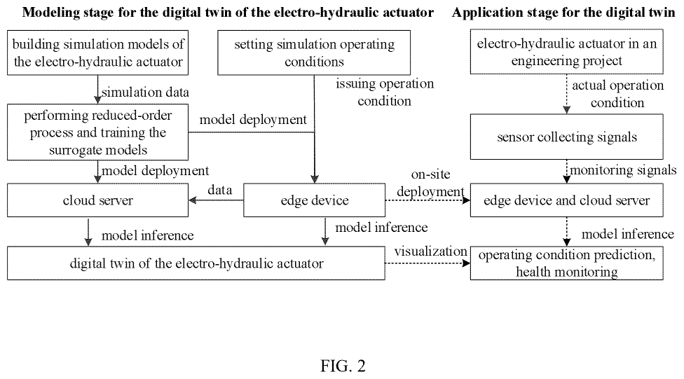

The step 110 may also be described in combination with FIG. 2 in followings.

At step S120, the plurality of surrogate models of the target electro-hydraulic actuator are obtained and deployed on an edge device and a cloud server based on a computing power requirement and an input parameter quantity of the plurality of surrogate models.

That is, surrogate models of the target electro-hydraulic actuator are built using model order reduction and deep learning methods, and the surrogate model is deployed on an edge device and a cloud server based on computing power requirements and input parameter quantities.

In some embodiments, the surrogate models are obtained by performing the following steps: generating multiple sample points of a simulation operating condition variable using Latin hypercube sampling method, and determining the simulation data of the multiple sample points of the simulation operating condition variable using the multiple simulation models; performing a proper orthogonal decomposition on the simulation data, and obtaining the low-dimensional data corresponding the original simulation data of each sample point to form a training data set; training neural network models using the training data set to obtain multiple surrogate models trained.

In some embodiments, the step of performing a proper orthogonal decomposition on the simulation data, and obtaining the low-dimensional data corresponding to the original simulation data of each sample point to form a training data set, may include: performing the proper orthogonal decomposition on the simulation data to obtain a singular value matrix and a right singular vector matrix; selecting multiple singular values from the singular value matrix and multiple singular vectors corresponding to the singular values from the right singular vector matrix; determining the low-dimensional data corresponding to the original simulation data of each sample point based on the multiple singular values and the multiple singular vectors; determining a training data pair formed by the simulation data and the low-dimensional data corresponding to the simulation data, in which the training data set includes the training data pairs.

In some embodiments, the surrogate models are deployed on one or more edge devices and one or more cloud servers respectively, for example, surrogate models with large inputting data volumes or high real-time requirements may be deployed on edge devices, and surrogate models with high computational complexity, large computing power requirements, or reliance on complex cloud technology stacks may be deployed on cloud servers.

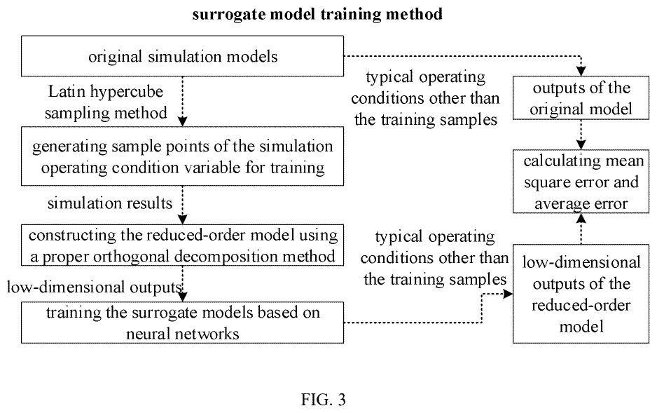

The step 120 may also be described in combination with FIG. 3 in followings.

At step S130, operating condition data of the target electro-hydraulic actuator are collected in real time, by at least one physical sensor of the target electro-hydraulic actuator.

That is, operating condition data of the target electro-hydraulic actuator are collected in real time.

In some embodiments, the operating condition data collected by the at least one physical sensor equipped in the target electro-hydraulic actuator may include at least one of oil pressure, oil temperature, pipeline flow rate, current/voltage of the controller of the electro-hydraulic actuator. In other words, the operating condition data may include stress-field data, flow-field data, temperature-field data, and electromagnetic-filed data collected by one or more physical sensors.

In some embodiments, the step 130 may be implemented by performing the following steps: obtaining an original time step used during training the multiple surrogate models; collecting the operating condition data of the target electro-hydraulic actuator in real time using the physical sensors with the original time step.

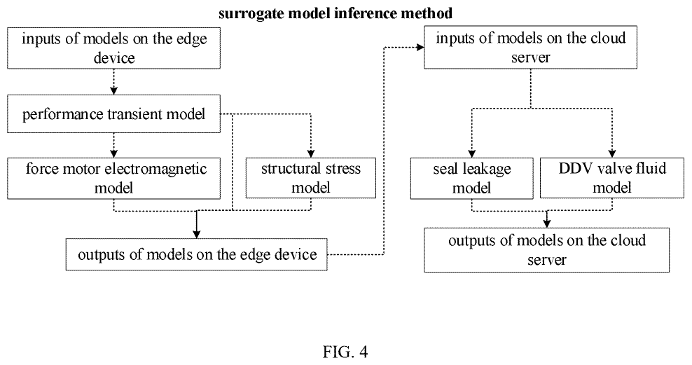

The step 130 may also be described in combination with FIG. 4 in followings.

At step S140, performance parameters of the target electro-hydraulic actuator under a current actual operating condition are determined or predicted based on the operating condition data using the multiple surrogate models on the edge device and the cloud server.

That is, the operating condition data are inputted into the surrogate models on the edge device and the cloud server, to perform real-time model inference to predict physical-field parameters and operating characteristic parameters of the target electro-hydraulic actuator under a current actual operating condition.

In some embodiments, model inference may be performed on the edge-cloud collaboration system including the edge device and the server.

The dynamic performance parameters may include physical-field parameters and operating characteristic parameters, and the physical-field parameters may include at least one of a pressure-field parameter, a stress-field parameter, a flow-field parameter, a temperature-field parameter, and an electromagnetic-field parameter. The operating characteristic parameters may include a damage cumulative parameter (such as a piston rod displacement, a wear mass loss of a dynamic seal, a leakage rate, etc.). In detail, the piston rod displacement may be determined by the system-level surrogate model, the wear mass loss of the dynamic seal and the leakage rate may be determined by the seal leakage surrogate model.

In some embodiments, the step 140 may be implemented by performing the following steps: determining, on the edge device, the operating characteristic parameters of the target electro-hydraulic actuator using a system-level surrogate model; determining, on the edge device, the performance parameters of the target electro-hydraulic actuator using a structural stress surrogate model; determining, on the edge device, the performance parameters of the target electro-hydraulic actuator using an electromagnetic surrogate model; determining, on the cloud server, the performance parameters of the target electro-hydraulic actuator using a seal leakage surrogate model; determining, on the cloud server, the performance parameters of the target electro-hydraulic actuator using a fluid surrogate model.

The step 140 may also be described in combination with FIG. 4 in followings.

At step S150, a graph of the operating characteristic parameters and a 3D model of the target electro-hydraulic actuator mapped with the physical-field parameters are obtained and displayed.

That is, a data fusion and a visualization process are performed on the physical field operating characteristic to construct a digital twin reflecting an operating condition of the target electro-hydraulic actuator, which means that the digital twin may be generated to show a real-time change on a 3D model of the target electro-hydraulic actuator and the parameters changes related to the target electro-hydraulic actuator.

In some embodiments, a displaying interface may be displayed on a display screen, in which dynamic graphs of the operating characteristic parameters and dynamic 3D models of the target electro-hydraulic actuator mapped with the physical-field parameters may be included in the interface. In addition, dynamic graphs of the control parameters may also be included in the interface.

In some embodiments, the step 150 may be implemented by performing the following steps: obtaining a vertex information file of the 3D model; obtaining a surrogate node information file of the multiple surrogate models; forming a pair by a vertex in the vertex information file and a node in the surrogate node information file using a spatial matching algorithm; determining a result value in a color gradient of each physical-field parameter corresponding to the node; mapping the result value to the vertex and recoloring the 3D model using a vertex coloring method, and displaying the graph of the operating characteristic parameters and the 3D model mapped with the result value.

The display interface may be displayed on a device with a display screen. The device may be the edge device, or an independent display device such as a computer or a terminal device. The display device may be connected to the edge device and the cloud server to receive the inference data (the performance parameters described above), and the control parameters provided by the control device. The display interface may also be displayed on a webpage, which is not limited herein. The device may also have capability to process the inference data. In an example, the device may be a monitoring platform of the electro-hydraulic actuator, and the digital twin may be embed into the monitoring platform.

In some embodiments, the performance parameters outputted from the surrogate models may be processed to generate one or more dynamic diagrams. For example, a dynamic diagram in which the target electro-hydraulic actuator with a reciprocating piston rod is displayed at a central area of the display interface. Moreover, several dynamic curve graphs reflecting the changes in the operating characteristic parameters are displayed, including curve graphs reflecting the changes in the damage cumulative parameters (such as a piston rod displacement, a wear mass loss of a dynamic seal, a leakage rate, etc.). Furthermore, dynamic 3D model diagrams mapped with the physical-field parameters may be displayed. The 3D model diagrams may include: a model diagram of the solenoid valve in the electro-hydraulic actuator, which reflects changes in the pressure-field parameter of the valve, a model diagram of the solenoid valve in the electro-hydraulic actuator, which reflects changes in the temperature-field parameter of the valve, a model diagram of the piston rod of the electro-hydraulic actuator, which reflects changes in the stress-field parameter of the piston rod, a model diagram of the force motor of the electro-hydraulic actuator, which reflects changes in the electromagnetic-field parameter of the force motor. In addition, curve graphs reflecting the changes in the control parameters such as an oil temperature, a control signal, a load force, etc. may also be displayed.

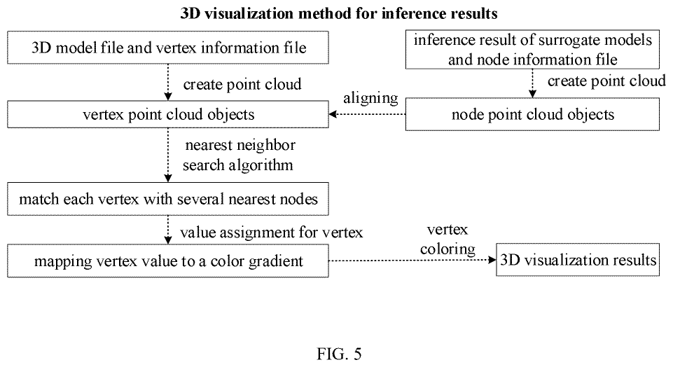

The step 150 may also be described in combination with FIG. 5 in followings.

With the method of the present disclosure, low latency of edge devices may be combined with the high computational power of cloud servers by adopting the edge-cloud collaboration, which provides a system capable of real-time functionality and high modeling accuracy. Health monitoring of the electro-hydraulic actuator may be performed within a short time by achieving real-time, high-precision modeling of the condition information of the electro-hydraulic actuator, thereby improving both response speed and prediction accuracy. Moreover, the method is highly efficient and optimizes resource usage, and by adopting model order reduction and surrogate model techniques, reliance on traditional simulation models and computational complexity may be reduced. At the same time, the edge-cloud collaboration improves the allocation of computing resources, thereby enhancing the overall efficiency of the monitoring system. In other words, the method provides intuitive visualization through the comprehensive construction of digital twins for electro-hydraulic actuators, offering a clear depiction of device operating condition and facilitating easier monitoring and analysis.

In some embodiments, as shown in FIG. 2, the digital twin modeling method may be described as follows.

The simulation models of the electro-hydraulic actuator may be built using the simulation software.

The simulation data may be generated using the simulation model, and multiple surrogate models of performance parameters of the electro-hydraulic actuator using model order reduction and deep learning methods, and the surrogate models may be deployed on one or more edge devices and a cloud server based on computing power requirements and input parameter quantity of each surrogate model.

Operating condition data of the target electro-hydraulic actuator may be collected in real time using at least one physical sensor configured in the electro-hydraulic actuator.

The collected sensor data may be inputted into the surrogate models, and a real-time model inference may be performed on the edge device and/or the cloud server, such that respective performance parameters of the electro-hydraulic actuator under a current actual operating condition may be predicted.

A data fusion and a visualization process may be performed on the inference result of the surrogate model on the cloud server side, so as to construct a comprehensive digital twin that fully reflects the key operating condition of the electro-hydraulic actuator, and the digital twin may be embed into the monitoring platform.

Finally, the entire operating system is deployed in an on-site monitoring environment to achieve real-time edge-cloud synchronization between the digital twin and the physical device.

In some embodiments, the step of building a high-fidelity simulation model of a target electro-hydraulic actuator using a simulation software (or, the step S110) may include: building a structural stress simulation model and an electromagnetic simulation model of the target electro-hydraulic actuator using the simulation software; building a fluid simulation model of the target electro-hydraulic actuator using the simulation software; building a system-level simulation model of the target electro-hydraulic actuator using the simulation software.

The structural stress simulation model and the electromagnetic simulation model of the electro-hydraulic actuator may be established using simulation software such as ANSYS and ABAQUS. The fluid simulation model of the electro-hydraulic actuator may be established using fluid simulation software or modules such as PumpLinx and ANSYS Fluent. AMESim simulation software may be used to establish the system-level simulation model of the electro-hydraulic actuator. The geometric characteristics and parameter settings of each simulation model may be consistent with the actual electro-hydraulic actuator to ensure high fidelity and reliability of the model.

As shown in FIG. 3, in some embodiments, the step of building surrogate models of an operating characteristic of the target electro-hydraulic actuator using model order reduction and deep learning methods (or, the step S120) may be implemented by performing following steps: generating a sample point of a simulation operating condition variable using Latin hypercube sampling method, and output simulation results under this operating point using the simulation model; constructing the reduced-order model with the simulation results using a proper orthogonal decomposition method, thereby obtaining a low-dimensional output corresponding to each sample to form a training data set; training surrogate models using the training data set to obtain the trained surrogate models.

In this embodiment, the Latin hypercube sampling method is used to generate sample points of the simulation operating condition variables. The simulation results of these sample points under the condition are output using a high-fidelity simulation model. Then, a reduced-order process is performed on the model and the neural network training may be performed. The original output data is used to construct a reduced-order model using the proper orthogonal decomposition method, so as to obtain the low-dimensional output corresponding to each sample, forming a training data set. A suitable surrogate model structure is selected and the surrogate model is trained. Next, model accuracy verification is performed on the trained surrogate model, and the error is calculated. Finally, the model is deployed and operated on the edge device and/or the cloud server which may be selected depending on the complexity of the surrogate model, the input parameter quantity, and the real-time requirements.

To ensure that the simulation data is complete and available, the sample points under the simulation condition need to be evenly distributed in the multidimensional space. Therefore, the Latin hypercube sampling method is used to generate sample points of the simulation operating condition variables. The value range of a certain operating condition variable is divided, and the width of the divided subinterval is defined as the following formula:

$$Δ = ( b - a ) / N ,$$

where Δ is the width of each subinterval, N is the total number of samples, a and b are the minimum and maximum values of the operating condition variable.

A number is selected randomly from each subinterval to obtain the sample point of the operating condition variable in this subinterval:

$${x}_{i} = a + ( ( i - 1 ) + {u}_{i} ) Δ ,$$

where xᵢ is a sample point of the parameter in the i-th subinterval, and uᵢ is a random number uniformly distributed between 0 and 1.

Similarly, for multi-dimensional operating condition variables, the sampling points are defined by the following formula:

$${x}_{ij} = {a}_{j} + [ ( {π}_{j} ( i ) - 1 ) + {u}_{ij} ] ( {b}_{j} - {a}_{j} ) / N ,$$

where xᵢⱼ is a sampling point of the i-th sample in the j-th dimension, aⱼ and bⱼ are the minimum and maximum values of the operating condition variable in the j-th dimension, πⱼ is a generated random permutation (i.e., a random permutation from 1 to N may be represented as πⱼ(1), πⱼ(2), . . . , πⱼ(N)), and uᵢⱼ is a random number uniformly distributed between 0 and 1.

Finally, the sampling points of all dimensions are combined into a multidimensional sample vector:

$${X}_{i} = ( {x}_{i 1} , {x}_{i 2} , … , {x}_{im} ) ,$$

where Xᵢ is the combined multidimensional sample vector, and m is the dimension of the sample.

In some embodiments, the step of performing the model order reduction on the simulation results using a proper orthogonal decomposition method, so as to obtain a low-dimensional output corresponding to each sample to form a training data set may be implemented by performing following steps: performing a proper orthogonal decomposition on the simulation results; selecting a certain number of singular values and corresponding singular vectors to obtain the low-dimensional output; forming a training data pair by the input sample and the low-dimensional output corresponding to the simulation result to obtain the training data set.

Specifically, the sample vector is used to obtain the original output data of the simulation model, which form the original output matrix:

$$Y = [ \begin{matrix}{y}_{1} & {y}_{2} & … & {y}_{N}\end{matrix} ] ∈ {▯}^{d \times N} ,$$

where Y is the original output matrix, y is the original output data for each sample point of the simulation model, N is the number of sample points, and dis the dimension of the original output data.

The original output is subjected to proper orthogonal decomposition, that is, the matrix Y is subjected to singular value decomposition:

$$Y = U Σ {V}^{T} ,$$

where U is the left orthogonal matrix and U∈ [symbol] , Σ is a diagonal matrix and Σ∈ [symbol] , and V is the right orthogonal matrix and V^{T}∈ [symbol] . U refers to the modal matrix. The matrix of modal coefficients B is represented by

$$B = {SV}^{T} ,$$

Several basis modes and coefficients are selected to perform the model order reduction. The number of selected basis modes k is determined once the cumulative energy ratio ε exceeds a predefined threshold α. The cumulative energy ratio ε is given by:

$$ε = {\sum }_{i = 1}^{k} {σ}_{i}^{2} / {\sum }_{i = 1}^{d} {σ}_{i}^{2} ,$$

where σᵢ is the i-th singular value in Σ. Y can be approximatively expressed using the selected modes:

$$Y \approx {U}_{k} {B}_{k} ,$$

where Uₖ∈ [symbol] and Bₖ∈ [symbol] are the modal matrix and the coefficient matrix after model order reduction. In this way, the low-dimensional Bₖ can be used to represent high-dimensional Y.

The input sample

$${\{ {X}_{i} \}}_{i = 1}^{N}$$

and the corresponding low-dimensional output Bₖ form a training data pair to train an appropriate surrogate model.

In some embodiments, a long short-term memory network may be used to construct the mapping relationship, which is particularly suitable for situations where real-time prediction is required.

In other embodiments, a radial basis function network may be used to construct the mapping relationship, which is suitable for situations with large data volumes and low real-time requirements.

As shown in FIG. 3, during the surrogate model training process, one or more representative operating condition samples that do not belong to the sample vectors may be selected, and these samples may be input into the trained reduced-order surrogate model to obtain the corresponding predicted output; the same operating condition samples may be input into the original simulation model to obtain the corresponding original simulation results; the predicted output of the surrogate model may be compared with the original simulation results to calculate the mean square error and average error.

In some embodiments, surrogate models with large data volumes or high real-time requirements are deployed in edge devices, while surrogate models with high computational complexity, large computing power requirements, or reliance on complex cloud technology stacks are deployed in cloud servers.

In some embodiments, the step of collecting operating condition data of the target electro-hydraulic actuator in real time (or, the step S130) may be implemented by performing following steps: obtaining an original time step used during training the surrogate model; and collecting the operating condition data of the target electro-hydraulic actuator in real time using at least one physical sensor with the original time step.

To meet the input requirements of the surrogate model, the sampling frequency of the actual operating state data signal of the electro-hydraulic actuator should be consistent with the inverse of the original time step used during the training process of the corresponding surrogate model:

$${f}_{i} = 1 / Δ {t}_{i} ,$$

where fᵢ is the sampling frequency of the i-th state data signal, and Δtᵢ is the time step used during the training process of the surrogate model corresponding to the state data, in seconds.

As shown in FIG. 4, in some embodiments, the step of inputting the operating condition data into the surrogate model to perform real-time model inference on an edge device and a cloud server (or, the step S140) may be implemented by performing the following steps: performing an electro-hydraulic actuator system-level model inference using the edge device; performing a piston rod structural stress model inference using the edge device; performing a force motor electromagnetic model inference using the edge device; performing a seal leakage model inference using the cloud server; performing a solenoid valve fluid model inference using the cloud server.

In the present embodiment, key operating condition data such as the oil pressure, oil temperature, pipeline flow rate, current and voltage of the controller of the electro-hydraulic actuator may be collected according to the sampling frequency set by the at least one physical sensor in the above-mentioned embodiment.

At the same time, an MQTT Broker, which may be regarded as a router or a relay device, is connected among the edge device, the server, and a control device for providing control command to the electro-hydraulic actuator. The edge device and the server may obtain required data from the MQTT Broker to perform the model inference. The current operating condition data collected by the sensors, as well as control parameters provided by the control device, may be transmitted to the edge device and the server through the MQTT Broker.

For the surrogate model deployed on the edge device and the server, the corresponding data transmitted through the MQTT Broker may be used as input parameters for model inference. For surrogate models where inputs and outputs are coupled and dependent on each other, the inference order needs to be determined.

The system-level surrogate model (the performance transient model shown in FIG. 4) is derived from the AMESim simulation software. The surrogate model structure is based on the long short-term memory network, saved in the onnx format, and inferred in the edge device through onnxruntime library. The onnxruntime library may be regarded as an engine.

The inputs of the system-level surrogate model include the control parameters including a motion amplitude, a frequency, the number of cycle periods and external load force of the electro-hydraulic actuator, and the outputs include a cylinder displacement, a solenoid valve core displacement, an electromagnetic force motor driving current, an inner cavity pressure, an outer cavity pressure, and a force acting on the solenoid valve core of the electro-hydraulic actuator.

The outputs of the system-level surrogate model may be inputs of the other surrogate models.

The piston rod structural stress surrogate model (the structural stress model shown in FIG. 4) is derived from the ANSYS simulation software. The surrogate model structure is based on a radial basis function network, saved in the pkl format, and inferred in the edge device through the joblib library.

The inputs of the piston rod structural stress surrogate model include an external load force in the control parameters, a cylinder displacement of the electro-hydraulic actuator and an internal cavity pressure. The outputs include a stress of the internal node of the piston rod, a stress at two measuring points on the cylinder wall, and a stress at the piston rod earring.

The force motor electromagnetic surrogate model (the force motor electromagnetic model shown in FIG. 4) is derived from the electromagnetic module of the ANSYS simulation software. The surrogate model structure is based on the radial basis function network, saved in the pkl format, and inferred in the edge device through the joblib library.

The inputs of the force motor electromagnetic surrogate model include a magnetic flux of the permanent magnet of the linear force motor, a driving current of the linear force motor, an external load force in the control parameters, and the displacement of the actuator cylinder of the electro-hydraulic actuator. The outputs include the magnetic induction intensity of the internal nodes of the linear force motor and the output force of the linear force motor.

The seal leakage surrogate model (the seal leakage model shown in FIG. 4) is derived from the MATLAB Simulink simulation software. The surrogate model structure is based on the radial basis function network, saved in the FMU format, and inferred in the cloud server through the FMPy library.

The inputs of the seal leakage surrogate model include control parameters such as a motion amplitude, a frequency, the number of cycle periods and external load of the electro-hydraulic actuator, as well as the external cavity pressure output by the surrogate model. The outputs include the dynamic seal wear and leakage rate.

The solenoid valve fluid surrogate model (the DDV valve fluid model shown in FIG. 4) is derived from the ANSYS Fluent simulation module. The surrogate model structure is based on a radial basis function network. Its weight matrix, coordinate matrix, and correction matrix are saved in CSV format and inferred in the cloud server through a specific JavaScript script.

The inputs of the solenoid valve fluid surrogate model include the control parameters such as a motion amplitude, a frequency, the number of cycle periods of the electro-hydraulic actuator, and the collected oil temperature, and the outputs include the pressures of internal nodes in the solenoid valve and temperature of internal nodes in the solenoid valve.

As shown in FIG. 5, in some embodiments, the step of performing data fusion and visualization process on the physical field operating characteristic to construct a digital twin reflecting an operating condition of the target electro-hydraulic actuator (or, the step S150) may be implemented by performing the following steps: loading a 3D model file and a corresponding vertex information file; loading an inference result of the surrogate model and a corresponding surrogate node information file; forming a pair by a vertex in the 3D model and a node in the inference result of the surrogate model using a spatial matching algorithm; performing a mapping process and a normalization on the inference result of the surrogate model and the vertex, so as to obtain a result value; mapping the result value to a color gradient and recoloring the 3D model using a vertex coloring method.

In this embodiment, model files in formats such as fbx, stl, and gltf may be used, and the corresponding vertex information files may be saved in formats such as csv and json. The vertex information files contain the spatial three-dimensional coordinates of all vertices of the three-dimensional model.

For the 3D model files with sparse vertices, subdivision surface processing is required to ensure that the information may be effectively mapped. Specifically, the number of vertices in the 3D model file should be greater than the number of nodes corresponding to the output results of the surrogate model.

The surrogate model inference results may come from the surrogate model deployed on the edge device or from the surrogate model deployed on the cloud server. The corresponding surrogate node information file may be saved in formats such as csv and json. The surrogate node information file contains the spatial three-dimensional coordinates of all grid nodes divided during the simulation.

If the 3D model vertex coordinates and mesh node coordinates are stored in different length units, all coordinate values in the corresponding surrogate node information file may be multiplied by the corresponding scale factor to convert them into the same length unit.

All coordinate values of vertex information files and surrogate node information files with the same length unit are extracted to create point cloud objects, and the iterative closest point algorithm is used to align the node point cloud to the vertex point cloud.

The nearest neighbor search algorithm is used to match each vertex with the nearest nodes.

In some embodiments, one node is matched.

In other embodiments, the number of matched nodes is defined using the following formula:

$$n = ⌈ V / N ⌉ ,$$

where n is the number of matched nodes, V is the total number of vertices, Nis the total number of nodes, and ┌⋅┐ is the round-up operation.

The inference results of the surrogate model are mapped to all vertices of the 3D model based on the matched nodes. That is, all vertices of the 3D model may assign calculated values, which are defined using the following formula:

$${Vertex}_{i} = ( {\sum }_{{j = 1}^{}}^{n} N o d {e}_{j} ) / n ,$$

where Vertexᵢ is the calculated value assigned to the vertex of the 3D model, Nodeⱼ is the value of the node corresponding to the inference result of the surrogate model, n is the number of matched nodes, and i and j are the indices of the vertex and node.

The calculated values assigned to all vertices may be mapped to a color gradient. For example, low values may be mapped to cold tones and high values may be mapped to warm tones, and the model is recolored using the vertex coloring method.

The digital twin operation system consists of monitoring sensors in the electro-hydraulic actuator system, an edge computing device, and a cloud server. The operation system of a digital twin of the electro-hydraulic actuator is shown in FIG. 6.

In the edge computing node, the edge computing device has modules, such as CPU, network port communication module, and WLAN communication module etc., to realize the communication function between the edge device and the AD conversion module, the monitoring signal processing and surrogate model inference function, and the communication function between the edge device and the cloud server. The cloud server and edge computing device are connected via the MQTT protocol.

It should be noted that the digital twin modeling method for an electro-hydraulic actuator with edge-cloud collaboration provided in the embodiment of the present disclosure may be executed by a digital twin modeling apparatus for an electro-hydraulic actuator with edge-cloud collaboration, or a control module, in the digital twin modeling apparatus for an electro-hydraulic actuator with edge-cloud collaboration, configured for executing the digital twin modeling method for an electro-hydraulic actuator with edge-cloud collaboration. In the embodiment of the present disclosure, the digital twin modeling method may be executed by the digital twin modeling apparatus, which is taken as an example in the present disclosure.

In some embodiments of the present disclosure, a digital twin modeling system for an electro-hydraulic actuator with edge-cloud collaboration is provided, the system includes: a processor, a memory, and a program or an instruction stored on the memory and executable on the processor, in which when the program or the instruction is executed by the processor, steps of the digital twin modeling method for an electro-hydraulic actuator with edge-cloud collaboration described in above embodiments are implemented.

The digital twin modeling system for an electro-hydraulic actuator with edge-cloud collaboration in the embodiment of the present disclosure may be an apparatus, or a component, an integrated circuit, or a chip in a terminal. The system may be a mobile electronic device or a non-mobile electronic device. Exemplarily, the mobile electronic device may be a mobile phone, a tablet computer, a laptop computer, an in-vehicle electronic device, a wearable device, an ultra-mobile personal computer (UMPC), a netbook, or a personal digital assistant (PDA), etc., and the non-mobile electronic device may be a server, a network attached storage (NAS), a personal computer (PC), a television (TV), an ATM, or an kiosks, etc., which are not specifically limited in the embodiments of the present disclosure.

The digital twin modeling system for an electro-hydraulic actuator with edge-cloud collaboration in the embodiment of the present disclosure may be a device with an operating system. The operating system may be an Android operating system, an iOS operating system, or other possible operating systems, which are not specifically limited in the embodiments of the present disclosure.

The digital twin modeling system for an electro-hydraulic actuator with edge-cloud collaboration provided in the embodiment of the present disclosure may implement each process implemented in the method embodiment of FIG. 1, which will not be repeated here.

The present disclosure provides a non-transitory computer-readable storage medium storing computer instructions, in which when the computer instructions are executed, the computer is caused to implement the method according to the above embodiments.

An electronic device for implementing the method according to above embodiments of the present disclosure may be provided. Electronic devices are intended to represent various forms of digital computers, such as laptop computers, desktop computers, workbenches, PDAs, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the present disclosure described and/or required herein.

The electronic device may include one or more processors, a memory, and interfaces for connecting various components, including a high-speed interface and a low-speed interface. Specifically, the electronic device may include one or more sensors for collecting data described above. The various components are interconnected using different buses and may be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses may be used with a plurality of memories and processors, if desired. Similarly, a plurality of electronic devices may be connected, each providing some of the necessary operations (for example, as a server array, a group of blade servers, or a multiprocessor system).

The memory is a non-transitory computer-readable storage medium according to the present disclosure. The memory stores instructions executable by at least one processor, so that the at least one processor executes the method according to the present disclosure. The non-transitory computer-readable storage medium of the present disclosure stores computer instructions, which are used to cause a computer to execute the method according to the present disclosure.

As a non-transitory computer-readable storage medium, the memory is configured to store non-transitory software programs, non-transitory computer executable programs and modules, such as program instructions/modules corresponding to the method in the embodiment of the present disclosure. The memory may include a high-speed random access memory, and a non-transitory memory, such as at least one magnetic disk storage device, a flash memory device, or other non-transitory solid-state storage device. In some embodiments, the memory may optionally include a memory remotely disposed with respect to the processor, and these remote memories may be connected to the electronic device through a network. Examples of the above network include, but are not limited to, an internet, an intranet, a local area network, a mobile communication network, and combinations thereof.

The electronic device for implementing the method may further include: an input device and an output device. The input device may receive inputted numeric or character information (such as collected data of the electro-hydraulic actuator), and generate key signal inputs related to user settings and function control of an electronic device, such as a touch screen, a keypad, a mouse, a trackpad, a touchpad, an indication rod, one or more mouse buttons, trackballs, joysticks and other input devices. The output device may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen. The output device may display the generated digital twin as described in above embodiments of the present disclosure.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

It should be understood that various forms of processes shown above may be used to reorder, add, or delete steps. For example, the steps described in the present disclosure may be performed in parallel, sequentially, or in different orders. As long as the desired results of the technical solutions disclosed in the present disclosure may be achieved, no limitation is made herein.

The embodiments of the present disclosure are described above in conjunction with the accompanying drawings, but the present disclosure is not limited to the above-mentioned specific implementation methods. The above-mentioned specific implementation methods are merely illustrative and not restrictive. Under the guidance of the present disclosure, those skilled in the art should understand that various modifications, combinations, sub-combinations, and substitutions may be made according to design requirements and other factors. Any modification, equivalent replacement and improvement made within the spirit and principle of the present disclosure shall be included in the protection scope of the present disclosure.

What is claimed is:

1. A digital twin modeling method for an electro-hydraulic actuator with edge-cloud collaboration, comprising:
obtaining a plurality of simulation models of a target electro-hydraulic actuator, and generating simulation data using the simulation models, wherein low-dimensional data corresponding to the simulation data is configured to train a plurality of surrogate models corresponding to the plurality of simulation models;
obtaining the plurality of surrogate models of the target electro-hydraulic actuator, and deploying the plurality of surrogate models on an edge device and a cloud server based on a computing power requirement and an input parameter quantity of the plurality of surrogate models;
collecting, by at least one physical sensor of the target electro-hydraulic actuator, operating condition data of the target electro-hydraulic actuator in real time;
determining, on the edge device and the cloud server, performance parameters of the target electro-hydraulic actuator under a current actual operating condition based on the operating condition data using the plurality of surrogate models, wherein the performance parameters comprise physical-field parameters and operating characteristic parameters, and the physical-field parameters comprise a stress-field parameter, a flow-field parameter and a temperature-field parameter; and
displaying a graph of the operating characteristic parameters and a 3D model of the target electro-hydraulic actuator mapped with the physical-field parameters.

2. The digital twin modeling method according to claim 1, wherein the obtaining a plurality of simulation models of a target electro-hydraulic actuator, comprises:
obtaining a structural stress simulation model and an electromagnetic simulation model of the target electro-hydraulic actuator;
obtaining a fluid simulation model of the target electro-hydraulic actuator;
obtaining a system-level simulation model of the target electro-hydraulic actuator.

3. The digital twin modeling method according to claim 1, wherein the obtaining the plurality of surrogate models of the target electro-hydraulic actuator, comprises:
generating a plurality of sample points of a simulation operating condition variable using Latin hypercube sampling method, and determining the simulation data of the plurality of sample points of the simulation operating condition variable using the plurality of simulation models;
performing a proper orthogonal decomposition on the simulation data, and obtaining the low-dimensional data corresponding the simulation data of each sample point to form a training data set;
training neural network surrogate models using the training data set to obtain the plurality of surrogate models trained.

4. The digital twin modeling method according to claim 3, wherein the performing a proper orthogonal decomposition on the simulation data, and obtaining the low-dimensional data corresponding to the simulation data of each sample point to form a training data set, comprises:
performing the proper orthogonal decomposition on the simulation data to obtain a singular value matrix and a right singular vector matrix;
selecting a plurality of singular values from the singular value matrix and a plurality of singular vectors corresponding to the singular values from the right singular vector matrix;
determining the low-dimensional data corresponding to the simulation data of each sample point based on the plurality of singular values and the plurality of singular vectors;
determining a training data pair by the simulation data and the low-dimensional data corresponding to the simulation data to obtain the training data set.

5. The digital twin modeling method according to claim 1, wherein the collecting, by at least one physical sensor of the target electro-hydraulic actuator, operating condition data of the target electro-hydraulic actuator in real time, comprises:
obtaining an original time step used during training the plurality of surrogate models;
collecting the operating condition data of the target electro-hydraulic actuator in real time using the at least one physical sensor with the original time step.

6. The digital twin modeling method according to claim 1, wherein the determining, on the edge device and the cloud server, performance parameters of the target electro-hydraulic actuator under a current actual operating condition based on the operating condition data using the plurality of surrogate models, comprises:
determining, on the edge device, the performance parameters of the target electro-hydraulic actuator using a system-level surrogate model;
determining, on the edge device, the performance parameters of the target electro-hydraulic actuator using a structural stress surrogate model;
determining, on the edge device, the performance parameters of the target electro-hydraulic actuator using an electromagnetic surrogate model;
determining, on the cloud server, the performance parameters of the target electro-hydraulic actuator using a seal leakage surrogate model;
determining, on the cloud server, the performance parameters of the target electro-hydraulic actuator using a fluid surrogate model.

7. The digital twin modeling method according to claim 1, wherein the displaying a graph of the operating characteristic parameters and a three dimensional (3D) model of the target electro-hydraulic actuator mapped with the physical-field parameters, comprises:
obtaining a vertex information file of the 3D model;
obtaining a surrogate node information file of the plurality of surrogate models;
forming a pair by a vertex in the vertex information file and a node in the surrogate node information file using a spatial matching algorithm;
determining a result value in a color gradient of each physical-field parameter corresponding to the node;
mapping the result value to the vertex and recoloring the 3D model using a vertex coloring method, and displaying the graph of the operating characteristic parameters and the 3D model mapped with the result value.

8. A digital twin modeling system for an electro-hydraulic actuator with edge-cloud collaboration, comprising: a processor, a memory, and a program or an instruction stored on the memory and executable on the processor, wherein when the program or the instruction is executed by the processor, a digital twin modeling method for an electro-hydraulic actuator with edge-cloud collaboration is implemented, the method comprises:
obtaining a plurality of simulation models of a target electro-hydraulic actuator, and generating simulation data using the simulation models, wherein low-dimensional data corresponding to the simulation data is configured to train a plurality of surrogate models corresponding to the plurality of simulation models;
obtaining the plurality of surrogate models of the target electro-hydraulic actuator, and deploying the plurality of surrogate models on an edge device and a cloud server based on a computing power requirement and an input parameter quantity of the plurality of surrogate models;
collecting, by at least one physical sensor of the target electro-hydraulic actuator, operating condition data of the target electro-hydraulic actuator in real time;
determining, on the edge device and the cloud server, performance parameters of the target electro-hydraulic actuator under a current actual operating condition based on the operating status data using the plurality of surrogate models, wherein the performance parameters comprise physical-field parameters and operating characteristic parameters, and the physical-field parameters comprise a stress-field parameter, a flow-field parameter and a temperature-field parameter; and
displaying a graph of the operating characteristic parameters and a 3D model of the target electro-hydraulic actuator mapped with the physical-field parameters.
